(19) United States
(12) Patent Application Publication
(10) Pub. No.: US 2026/0285697 A1
(43) Pub. Date: Sep. 24, 2026

(54) A PROCESS FOR PREPARING HIGH-PURITY ALKALI METAL HEXAFLUOROPHOSPHATE AND THE ALKALI METAL HEXAFLUOROPHOSPHATE PREPARED THEREFROM

(71) Applicants: GUJARAT FLUOROCHEMICALS LIMITED, Panchmahal, Gujarat (IN); GFCL EV PRODUCTS LIMITED, Noida (IN)

(72) Inventors: Vijay Kumar SONI, New Delhi, Delhi (IN); S.b. GAITONDE, Bhayali TP-1, Gujarat (IN); Bapu GANGURDE, Vadodara, Gujarat (IN); Vijaykumar IJERI, Bharuch, Gujarat (IN); Vitthal Genbhau GUND, Mumbai, Maharashtra (IN); Manoj Kunjabihari AGRAWAL, Chikhali, Maharashtra (IN); Rajendra Karbhari WAJE, Nasik, Maharashtra (IN)

(21) Appl. No.: 19/166,058

(22) PCT Filed: Mar. 20, 2024
(86) PCT No.: PCT/IN2024/050286

§ 371 Date: Sep. 17, 2025

(30) Foreign Application Priority Data
Mar. 20, 2023 (IN) 202321004164

(51) Int. Cl. C01D 13/00; C01D 17/00

(52) U.S. Cl. CPC C01D 13/00; C01D 17/00; C01P 2006/80

(57) ABSTRACT

The present disclosure relates to process of preparing an ultra-high purity alkali metal hexafluorophosphate (MPF6).

### CROSS-REFERENCE TO RELATED APPLICATIONS

The present application is a U.S. National Phase Entry of International PCT Application No. PCT/IN2024/050286 having an international filing date of Mar. 20, 2024, which claims the priority to, and benefit of Indian Patent Application number 202321004164 filed on Mar. 20, 2023. The disclosures of the above-identified applications are incorporated herein by reference in their entirety.

### FIELD OF THE INVENTION

The present disclosure relates to a process for preparing alkali metal hexafluorophosphate. More particularly, the present invention relates to a process for preparing high purity alkali hexafluorophosphate based on Group 1 elements, preferably selected from Sodium Hexafluorophosphate (NaPF₆), Potassium Hexafluorophosphate (KPF₆) and Cesium Hexafluorohosphate (CsPF₆). The alkali hexafluorophosphates are useful as an electrolyte in batteries for stationary storage batteries, low-speed electric vehicles.

### BACKGROUND OF THE INVENTION

Lithium-ion batteries (LIBs) have found application in various sectors over the years, since its commercialization in 1991. Starting from its usage in portable electronics, currently its requirement is majorly shifting towards Electric Vehicles (EV) & Energy Storage Systems (ESS) applications. This leads to the unprecedented demand for the core raw material of LIB, that is “Lithium”. Globally the demand of lithium by 2030 would be 2.5 million tons as per Statista report while the demand of the same in 2021 was 0.5 million tons. But the challenge is Lithium is less abundant in earth's crust, which creates a serious threat of its availability in future. So, the need of hours is to find the right alternative to the lithium-ion batteries. Here, the Sodium-ion batteries come into play.

Sodium and potassium fall under the same group of lithium in periodic table and reflect the similar characteristics of the lithium. Accordingly, electrolytes based on sodium and potassium are of interest.

Sodium is the sixth most abundant element in the earth's crust and so there is no threat to its availability. Although the sodium-ion batteries (NIBs) have their limitations in adapting it for high-speed EVs as of now, it perfectly suits for the Energy Storage System (ESS) & low-speed vehicles applications. With the continuous R&D activity on sodium-ion batteries (NIBs) in the foreseeable future, it is expected that sodium-ion batteries would find its usage in the high-speed EVs too in the future. In that way, Sodium-ion batteries will become a potential alternative for the lithium-ion batteries in future.

Similarly, potassium-ion batteries (KIBs) are emerging as a promising energy storage system due to the abundance of potassium. The potassium-ion has certain advantages over similar lithium-ion (e.g., lithium-ion batteries): the cell design is simple, and both the material and the fabrication procedures are cheaper. The key advantage is the abundance and low cost of potassium in comparison with lithium, which makes potassium batteries a promising candidate for large scale batteries such as household energy storage and electric vehicles.

Though NaClO4 is the most studied electrolyte salt in Sodium-ion batteries (NIBs) and KClO4 in Potassium-ion batteries (KIBs), the strong oxidizing nature of perchlorate anion prohibits commercial use. Analogous to Lithium hexafluorophosphate (LiPF6): Sodium hexafluorophosphate (NaPF6), hexafluorophosphate Potassium (KPF6) or Cesium hexafluorophosphate (CsPF6) are electrolyte salts for sodium-ion, potassium-ion or cesium-ion batteries, respectively. Accordingly, they can undertake the mature battery technology that has been commercialized for example by Li-Battery salt with good solubility and ionic conductivity in battery solvents like ethylene carbonate, propylene carbonate, dimethyl carbonate, etc. and mixtures thereof.

For long term cycle life of batteries, it is necessary that the electrolyte salts are extremely pure.

In the conventional preparation of NaPF6, the PF5 gas is passed through a solution of NaF in HF, to form NaPF6. Thereafter, HF is removed and the NaPF6 is crystallized. However, one of the drawbacks of the conventional approach is that large amounts of impurity, in the form of Fluorinated solids sink down with NaPF6 crystals and get mixed together. Further, it is very difficult to decrease the amount of impurities such as fluorinated solids in NaPF6 without resorting to complex reactions, procedures and additional purification steps.

Similarly, for the preparation of KPF6, the PF5 gas is passed through a solution of KF in HF, to form KPF6. Thereafter, HF is removed and the KPF6 is crystallized. However, one of the drawbacks of the conventional approach is that large amounts of impurity, in the form of Fluorinated solids sink down with KPF6 crystals and get mixed together. Further, it is very difficult to decrease the amount of impurities such as Fluorinated solids in KPF6 without resorting to complex reactions, procedures and additional purification steps.

Impurities in the form of fluorinated solids causes erosion of the electrodes, which directly affects the capacity and performance of the batteries.

Further, the presence of various metallic impurities such as transition metal impurities is detrimental to battery performance. For example, the transition metal ions dissolved in the electrolytes might deposit on the anode surface. This might cause decomposition of NaPF6 and KPF6, sodium and potassium dendrite growth from the surface of the negative electrode and cause internal short circuit.

Water is yet another impurity of concern in Sodium-ion batteries and Potassium-ion batteries. The presence of water negatively affects the battery performance. The presence of excess water will also make the electrolyte acidify faster to generate HF gas, which is also one of the main reasons for battery flatulence, which reduces battery life.

Water can react with the NaPF6 and KPF6, thereby reducing the capacity of the battery. The presence of water is also implicated in poor cycling performance and loss of active materials. Water can destroy the protective solid electrolyte interface layer and get reduced at the anode to yield H2 gas. The presence of H2 gas increases the internal pressure of the batteries and is an explosion hazard.

Further, the conventional preparation method further suffer from drawbacks which do not allow the method to be carried out on a large scale such as back pressurization, choking problem and maintaining and controlling pressure for optimized purity.

Accordingly, there is a need to develop a process of preparing high purity alkali hexafluorophosphates, preferably selected form NaPF6, KPF6 or CsPF6 with reduced impurities which addresses one or more of the above-mentioned shortcomings.

### SUMMARY OF THE INVENTION

In one aspect, the present invention provides process of preparing an ultra-high purity alkali metal hexafluorophosphate (MPF6), comprising following steps: (a) charging alkali metal fluoride (MF) in a first reactor ‘B’ and flushing nitrogen gas through the same, (b) cooling the first reactor ‘B’ to a predetermined temperature, followed by charging anhydrous hydrogen fluoride (AHF) gas and stirring the mixture comprising alkali metal fluoride (MF) dissolved in AHF in the first reactor ‘B’, (c) cooling the mixture comprising alkali metal fluoride (MF) dissolved in AHF in the first reactor ‘B’ to a predetermined temperature, (d) charging phosphorous pentachloride (PCl5) in a second reactor ‘A’ and adding AHF in lots, to produce high purity phosphorous pentafluoride (PF5) and hydrogen chloride (HCl) gas, (e) reacting alkali metal fluoride (MF) dissolved in AHF in the first reactor ‘B’ with phosphorus pentafluoride (PF5) and hydrogen chloride (HCl) gas mixture obtained in step (d) to obtain alkali metal hexafluorophosphate mother liquor dissolved in AHF under PF5 gas blanketing, (f) cooling the first reactor ‘B’ to a predetermined temperature and maintaining the temperature of alkali metal hexafluorophosphate mother liquor dissolved in AHF for predetermined time, followed by filtration and drying at predetermined temperature to achieve alkali metal hexafluorophosphate (MPF6).

In another aspect, the present invention provides an ultra-high purity alkali metal hexafluorophosphate with an improved yield of at least 99.50%, preferably at least 99.8%.

### BRIEF DESCRIPTION OF THE DRAWINGS

Reference will be made to embodiments of the invention, examples of which may be illustrated in accompanying FIGURES. These FIGURES are intended to be illustrative, not limiting. Although the invention is generally described in the context of these embodiments, it should be understood that it is not intended to limit the scope of the invention to these particular embodiments.

FIG. 1 shows the process flow diagram.

### DETAILED DESCRIPTION OF THE INVENTION

It is to be noted that, as used in the specification, the singular forms “a,” “an,” and “the” include plural referents unless the context clearly dictates otherwise. Thus, for example, reference to a composition containing “a compound” includes a mixture of two or more compounds. It should also be noted that the term “or” is generally employed in its sense including “and/or” unless the content clearly dictates otherwise.

The expression of various quantities in terms of “%” or “% w/w” means the percentage by weight of the total solution or composition unless otherwise specified.

The present invention is directed towards a process of preparing ultra-high purity alkali metal hexafluorophosphate (MPF6) useful as an electrolyte in high strength batteries, preferably as an electrolyte in batteries for storage application.

In one of the embodiments the process of preparing ultra-high purity alkali metal hexafluorophosphate MPF6 (preferably M=Na, K or Cs) comprises the following steps:
a. charging alkali metal fluoride (MF) in a first reactor ‘B’ and flushing nitrogen gas through the same,
b. cooling the first reactor ‘B’ to a predetermined temperature, followed by charging anhydrous hydrogen fluoride (AHF) gas and stirring the mixture comprising alkali metal fluoride (MF) dissolved in AHF in the first reactor ‘B’,
c. cooling the mixture comprising alkali metal fluoride (MF) dissolved in AHF in the first reactor ‘B’ to a predetermined temperature,
d. charging phosphorous pentachloride (PCl5) in a second reactor ‘A’ and adding AHF in lots, to produce high purity phosphorous pentafluoride (PF5) and hydrogen chloride (HCl) gas,
e. reacting alkali metal fluoride (MF) dissolved in AHF in the first reactor ‘B’ with phosphorus pentafluoride (PF5) and hydrogen chloride (HCl) gas mixture obtained in step (d) to obtain alkali metal hexafluorophosphate mother liquor dissolved in AHF under PF5 gas blanketing,
f. cooling the first reactor ‘B’ to a predetermined temperature and maintaining the temperature of alkali metal hexafluorophosphate mother liquor dissolved in AHF for predetermined time, followed by filtration and drying at predetermined temperature to achieve alkali metal hexafluorophosphate (MPF6),
g. crushing the dried crystals of MPF6 and optionally sieving to obtain MPF6 powder.

Whenever PF5 gas is purged into the solution of MF/AHF, generally dip pipe gets choked, and the reaction mass gets back pressurized, which results in loss. Accordingly, the process reaction is carried out under PF5 gas blanketing and allowing back pressurization and choking problem to be completely resolved with the process of the present invention.

Further, according to the disclosed process, the pressure of the reaction mass can be controlled as per the requirement. Over pressurization is controlled by slow, and lot-wise addition of AHF to PCl5 containing reactor. The generated HCl and PF5 gas is blanketed in MF/HF reactor. Hence, pressure can be controlled by releasing excess gases into the scrubber having basic pH and the pressure can be maintained and controlled more effectively in scrubber, so that the flow of acidic fumes becomes unidirectional.

In an embodiment, the alkali metal is selected from Na, K and Cs and the alkali metal hexafluorophosphate is selected from NaPF6, KPF6 or CsPF6.

In an embodiment, the alkali metal fluoride is obtained from respective metal carbonate and hydrogen fluoride (HF). For example, sodium fluoride (NaF) and Potassium fluoride (KF) used in the process is obtained from sodium carbonate (Na2CO3) or potassium carbonate (K2CO3) respectively and hydrogen fluoride (HF).

In an embodiment of the present invention, the anhydrous hydrogen fluoride (AHF) gas is a purified anhydrous hydrogen fluoride (AHF) gas comprises cationic (metal) impurities less than or equal to 1 ppm or anionic impurities less than or equal to 1 ppm or moisture less than or equal to 1 ppm or combination thereof.

In yet another embodiment, the purified anhydrous hydrogen fluoride (AHF) gas reacts with PCl5 solid bed reactor with agitation.

In yet another embodiment, the anhydrous hydrogen fluoride (AHF) gas is purified by treatment with fluorine (F2) gas as an oxidizing agent.

In an embodiment of the process, the PF5 and HCl gas from the second reactor ‘A’ was dosed to the first reactor ‘B’ through vent system without any dip-tube till constant pressure.

In an embodiment of the process, the predetermined temperature in step (b) and (c) is in the range of 0 to 15° C., preferably in the range of 5 to 10° C.

In an embodiment of the process, the AHF is added in multiple lots preferably in the range of 200 to 300 g or 100 to 200 g at 25 to 40° C.

In an embodiment of the process, the predetermined temperature and predetermined time for cooling in step (f) is in the range of −10 to −25° C. for 5 to 7 hours.

In an embodiment of the process, the predetermined temperature and predetermined time for cooling in step (f) is in the range of −15 to −20° C. for 6 hours.

In an embodiment of the process, the predetermined temperature for drying in step (f) is in the range of 35 to 50° C., preferably between 38 to 40° C.

In a preferred embodiment, the process involves the use of static crystallizer which takes a single turn in about 48 hours so as to allow the crystals to grow slowly to a large size and minimize surface area for HF adsorption.

In another preferred embodiment, the mother liquor is re-used by adding alkali fluoride (preferably selected from NaF or KF or CsF) at −15 to 15° C., preferably at 10° C.

In a preferred embodiment, the drying of the crystallized alkali metal hexafluorophosphate is done by hot water circulation in the dryer jacket, followed by passing dry N2 to dry crystal for about 6-7 hours.

In yet another embodiment, the drying of crystallized alkali metal hexafluorophosphate followed by solvent assisted drying preferably with solvents such as ether or dichloromethane.

Another aspect of the process is to use a mesh size so as to have lower HF adsorbed crystals of larger size sifted out as the final product. The smaller crystals with higher adsorbed HF are re-circulated through the mother liquor. This reduces the total concentration of HF in the finished product, and the recovery of alkali metal hexafluorophosphate crystals for the next crystallization procedure of the crystal seed and also reduces production costs.

In a preferred embodiment, sieving of dried crystals of alkali metal hexafluorophosphate is done through mesh size of less than or equal to 90.

In another embodiment, the alkali metal fluorides (sodium fluoride, Potassium fluoride or Cesium fluoride) used in the process is obtained from the steps of dissolving alkali metal carbonate (preferably selected from sodium carbonate or potassium carbonate or Cesium Carbonate) in water to obtain alkali metal carbonate solution, reacting the alkali metal carbonate solution with ultra-pure hydrogen fluoride to obtain alkali metal fluorides such as sodium fluoride or potassium fluoride or cesium fluoride,

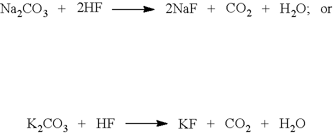

In another embodiment, the alkali metal fluorides (sodium fluoride, Potassium fluoride or Cesium fluoride) used in the process is obtained from the steps of dissolving treated pure alkali metal hydroxide in ultra-pure water to obtain alkali metal hydroxide solution, or lye solution (caustic lye and caustic potash solution); reacting the alkali metal hydroxide solution/caustic lye/caustic potash with ultra-pure hydrogen fluoride to obtain alkali metal fluoride (sodium fluoride or potassium fluoride or cesium fluoride),

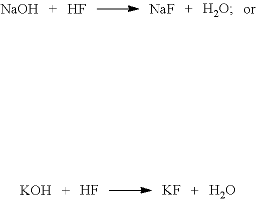

Followed by drying and crushing the obtained desired particle size range alkali metal fluoride (NaF or KF or CsF).

In another embodiment, the exhaust from the reactor comprising PF5, HCl, oxides of phosphorus and HF is re-guided into the mother liquor for the second stage reabsorption process, which improves the overall efficiency of the process.

In another embodiment, the gaseous exhaust from the mother liquor tank comprising HCl and HF is re-guided to a recovery system, which improves the overall efficiency of HF recovery.

Another aspect of the present invention relates to an ultra-high purity alkali metal hexafluorophosphate selected from NaPF6, KPF6 and CsPF6 with a purity of at least 98.50%, preferably at least 99.8%.

In a preferred embodiment of the present invention the ultra-high purity alkali metal hexafluorophosphate (preferably selected from NaPF6, KPF6 or CsPF6) comprises:
insoluble material in an amount less than or equal to 200 ppm, or
metallic impurities—each of which is present in an amount less than or equal to 2 ppm, or
hydrogen fluoride (HF) in an amount less than or equal to 70 ppm, or
sulfate ions (SO42-) in an amount less than or equal to 10 ppm, or
nitrate ions (NO3-) in an amount less than or equal to 5 ppm, or
chloride ions (Cl—) in an amount less than or equal to 5 ppm, or
water/moisture in an amount less than or equal to 10 ppm, or combination thereof.

In a preferred embodiment of the present invention the ultra-high purity alkali metal hexafluorophosphate (preferably selected from NaPF6, KPF6 or CsPF6) comprises metallic impurities as follows:

$$Na \leq 2 ppm$$

$$K \leq 2 ppm$$

$$Fe \leq 2 ppm$$

$$Zn \leq 2 ppm$$

$$Ni \leq 2 ppm$$

$$Mg \leq 2 ppm$$

$$Ca \leq 2 ppm$$

$$Pb \leq 2 ppm$$

$$Cr \leq 2 ppm$$

According to the process of the present invention, the high purity Phosphorus pentachloride (PCl5) is obtained from commercial sources. The gaseous high purity anhydrous hydrogen fluoride (AHF) reacts with the solid phosphorus pentachloride (PCl5) to produce phosphorus pentafluoride (PF5) and hydrogen chloride (HCl).

Impurities in alkali hexafluorophosphates are a direct consequence of the impurities present in the main raw materials, i.e., AHF and NaF or KF. Hence, as discussed below, the AHF and NaF or KF or CsF used in the present invention are purified to minimize moisture, insoluble and metallic impurities. In other words, only high purity battery grade AHF and NaF or KF or CsF are used in the present invention.

Usually, PCl5 is dissolved in AHF to prepare PF5. This results in impurities such as AsF5, BF4 etc. However, in the present invention, gaseous AHF reacts with solid PCl5 in a packed bed reactor. In addition to arsenic and boron-generated gas mixed into PF5, most of the impurities brought into PCl5 react with PF5 to form fluoride with high boiling point precipitation in the reactor and remain at the bottom in solid form. Thereafter, the resulting PF5 is passed through a filter to remove any PCl5 grains that might be adrift in the gas stream, to obtain a high purity PF5 gas. Accordingly, the process by virtue of being carried out in a packed bed reactor with high purity gaseous AHF eliminates or minimizes impurities and water in the PF5 gas.

PF5 produced in step (d) enters the first reactor ‘B’ wherein it reacts with the NaF or KF is dissolved or suspended in AHF. This results in the formation of NaPF6 or KPF6 or CsPF6 dissolved in AHF, also called as a mother liquor. Preferably, step (d) is carried out at a temperature in the range of −15 to 15° C., more preferably at 10° C.

The exhaust from the second reactor ‘A’ comprising PF5, HCl, oxides of phosphorus and HF is re-guided into the mother liquor for the second stage re-absorption process, which improves the overall efficiency of the reaction, particularly, by improving the recovery efficiency of PF5. After every 1 hr, the excess pressure due to HCl gas was scrubbed into scrubber having basic pH. After complete consumption of the HF and PCl5 (recognized by non-generation of PF5 gas pressure) the reactor was cooled to −15 to −20° C.

In an embodiment of the process, crystallization is carried out from the mother liquor preferably in a static crystallization tank, wherein the mother liquor is cooled. The mother liquor is cooled over an extended period.

The static crystallizer used in the present invention takes a single turn in 48 hours. The alkali metal hexafluorophosphate crystals are allowed to grow slowly to a large size. Larger size of the crystals of NaPF₆ or KPF₆ or CsPF₆ translates into lesser surface area for HF to get adsorbed onto, resulting in NaPF₆ or KPF₆ or CsPF₆ with minimum HF content. The crystals are separated by passing through mesh sieves. The separated larger crystals of NaPF₆ or KPF₆ or CsPF₆ are crushed and dried to obtain high purity powdered NaPF₆ or KPF₆ at temperatures of 60-70° C., under vacuum for about 6 hours to drive out maximum HF.

The smaller crystals of NaPF₆ or KPF₆ or CsPF₆ are re-used by adding a certain amount of Sodium fluoride (NaF) or Potassium fluoride (KF) or Cesium fluoride (CsF) respectively into the mother liquor at −15 to 5° C., preferably at −10° C. and the process repeated to get larger sized crystals.

If a regular rotating crystallizer is used instead of the static crystallizer, it will give rise to smaller crystals with HF content in the range 150-300 ppm. If higher temperatures are used for drying, there is decomposition and generation of HF from the NaPF₆ or KPF₆ or CsPF₆ crystals.

Discussed below are some representative embodiments of the present invention.

The invention in its broader aspects is not limited to the specific details and representative processes. An illustrative example is described in this section in connection with the embodiments and processes provided.

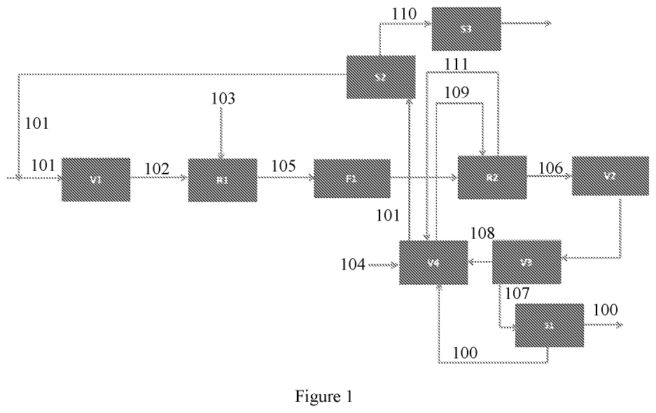

FIG. 1 illustrates the process flow diagram for preparing NaPF6 according to an embodiment of the present disclosure. According to the process HF solution (101) is passed through a vaporizer (V1) to convert HF into a gaseous state (102). The HF gaseous state (102) obtained from vaporizer (V1) is reacted with PCl5 powder (103) in first reactor (R1) to obtain intermediate products PF5, HCl (g) and unreacted trace HF (105).

The intermediate products (105) are passed through a filter (F1) and sent to a second reactor (R2) to obtain a product solution (106) comprising NaPF₆ and HF solution which is passed onto a hold-up tank (V2). The product solution (106) from the hold-up tank (V2) is passed onto the crystallizer (V3) wherein the product NaPF₆ (107) is recovered, and mother-liquid (108) is separated. The product (107) is passed through sieves (S1) to obtain the desired size product NaPF₆ and the remaining is recycled to the mother-liquid tank (V4). The mother-liquid (108) comprising NaF and HF solution is sent to a mother liquid tank (V4) wherein HF solution and NaF (104) are further added, and the treated mother-liquid (109) is recycled to the second reactor (R2) to obtain a product solution (106) comprising NaPF₆ and HF solution. The vent gases (111) from the mother-liquid tank (V4) are sent to a recovery system (S2) to reuse and recycle HF gases (101) and the unrecovered vent gases (110) are sent to 3-stage scrubber (S3) for disposal.

Impurities in NaPF6 are a direct consequence of the impurities present in the main raw materials, i.e., AHF and NaF. Hence, as discussed below, the AHF and NaF used in the present invention are purified to minimize moisture, insoluble and metallic impurities. In other words, only high purity AHF and NaF are used in the present invention.

In commercial HF, metals such as Fe, Ca, Mg react with active PF₅ in synthesis reaction vessel to form FeF3, CaF2, MgF2 which increases the impurities in NaPF6/KPF6 crystal. Accordingly, the AHF used in the present invention is purified prior to using it in the process of the present invention.

Commercial AHF is purified by treatment with fluorine (F2) as an oxidizing agent to fluorinate AHF impurities to remove most metals including Arsenic and boron compounds as gaseous impurities. If AHF is not purified by reacting with F₂, gaseous impurities such as metallic fluorides, AsF5 and BF4 might contaminate the mother liquor. Use of purified AHF in the present invention, further minimizes impurities in the NaPF6/KPF6 crystals of the present invention.

Preparation of high purity AHF: Pure Fluorine gas is purged into commercial AHF at a pressure of 3 kg/cm² for 3 min at temperature of 25° C. in a reaction vessel. After the impurities are precipitated as fluorides, the pure AHF is transferred to distillation column from the reaction vessel. The impurity levels of commercial vs purified AHF are provided below:

Impurity Level: Commercial AHF Vs. Purified AHF

| Impurity | Commercial AHF | Purified AHF |
|---|---|---|
| Moisture | ≤250 ppm | ≤1 ppm |
| Fe | ≤3 ppm | ≤0.1 ppm |
| Ca | ≤3 ppm | ≤0.1 ppm |
| K | ≤3 ppm | ≤0.1 ppm |
| Na | ≤3 ppm | ≤0.1 ppm |
| Ni | ≤3 ppm | ≤0.1 ppm |
| Pb | ≤3 ppm | ≤0.1 ppm |
| Zn | ≤3 ppm | ≤0.1 ppm |
| Cr | ≤3 ppm | ≤0.1 ppm |
| Cu | ≤3 ppm | ≤0.1 ppm |
| Mg | ≤3 ppm | ≤0.1 ppm |
| Al | ≤3 ppm | ≤0.1 ppm |
| As | ≤3 ppm | ≤0.1 ppm |
| B | ≤3 ppm | ≤0.1 ppm |
| H₂SiF₆ | ≤250 ppm | ≤10 ppm |
| H₂SO₄ | ≤150 ppm | ≤3 ppm |

Insoluble impurities such as silicates, fluorosilicates and sulphates of metals, such as Fe, Ca, K, Na, Ni, Pb, Zn, Cr, Mg, Cu, and Al are present in NaF. Some metals do not dissolve in AHF and remain as solid particles. Some react with AHF to form fluoride material, for example, FeF₃, Na_{F}, CaF₂, MgF₂. The fluoride material, in these cases, precipitates as a solid at the bottom of the crystallizer and stays with NaPF6 crystals. This is the main cause of impurities in NaPF₆. These insoluble impurities end up in the NaPF₆ thereby increasing the combined levels of Ca, Mg, Na, K, etc above 100 ppm. Accordingly, in order to produce high purity NaPF₆, the NaF used in the process must be free of said metallic impurities.

Preparation of high purity NaF: Commercial Na₂CO₃ is mixed with pure deionized water to prepare a solution. The insoluble impurities are filtered off by passing the Na₂CO₃ solution through two series of cartridge filters. The soluble impurities are then removed by passing the Na₂CO₃ solution through cation and anion exchange resin columns.

The purified Na₂CO₃ solution is then reacted with 50% HF to neutralization yielding NaF. The NaF so formed, is filtered and dried by evaporating water at 130° C.

The purified NaF has metallic impurities below 2 ppm each, and the anionic impurities such as chlorides and sulphates below 5 ppm each.

Alternatively, purified sodium hydroxide (NaOH) or caustic lye may be used instead of sodium carbonate (Na₂CO₃).

Preparation of NaPF6—The high purity AHF produced as above, is added to solid PCl5 and the mixture of PF5+HCl+HF generated from this reaction is fed into a solution of NaF+AHF to produce NaPF6 in AHF solvent. NaPF6 is crystallized from this solution, filtered and dried to get the pure product.

The impurity levels of ultra-high purity NaPF6 according to the present process are provided below:

### Impurity Level of Ultra-High Purity NaPF6:

$$Fe \leq 2 ppm$$

$$Ca \leq 2 ppm$$

$$K \leq 2 ppm$$

$$Na \leq 2 ppm$$

$$Ni \leq 2 ppm$$

$$Pb \leq 2 ppm$$

$$Zn \leq 2 ppm$$

$$Cr \leq 2 ppm$$

$$Cu \leq 2 ppm$$

$$Mg \leq 2 ppm$$

The NaPF6 obtained by the process described hereinabove comprises insoluble material in an amount less than or equal to 200 ppm, and/or comprises metallic impurities—each of which is present in an amount less than or equal to 1 ppm, and/or comprises HF in an amount less than or equal to 70 ppm, and/or comprises SO₄²⁻ in an amount less than or equal to 10 ppm, and/or comprises NO³⁻ in an amount less than or equal to 5 ppm, and/or comprises Cl′ in an amount less than or equal to 5 ppm and/or comprises water in an amount less than or equal to 10 ppm or combination thereof.

The purity of NaPF6 obtained by the process of the present invention is at least 99.5%, preferably at least 99.8%.

In the absence of the AHF purification process, preparation of high purity NaF and the crystallization and drying steps, the metallic impurities get carried over and become a part of the final product i.e., NaPF₆. The NaPF₆ impurity profile then has a total metallic impurity of 30-80 ppm instead of less than or equal to 1 ppm.

Along similar lines, Potassium hexafluorophosphate (KPF₆) may be prepared by using Potassium fluoride (KF) and Phosphorus pentafluoride (PF₅). Eventually, potassium fluoride (KF) is prepared using potassium carbonate (K₂CO₃) or potassium hydroxide (KOH).

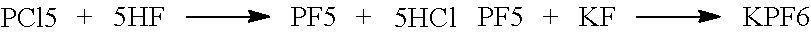

Similarly, Cesium hexafluorophosphate (CsPF₆) may be prepared by using Cesium fluoride (CsF) and Phosphorus pentafluoride (PF5). Eventually, Caesium fluoride (CsF) is prepared using Cesium carbonate (Cs₂CO₃) or Cesium hydroxide (CsOH).

Also, high purity alkali metal hexafluorophosphates of other Group 1 elements (Rb and Fr) can be prepared following the above scheme.

### EXAMPLES

The following examples are illustrative of the invention but not limitative of the scope thereof:

### Example-1: Synthesis of Sodium Hexafluorophosphate Using 1:1.2 Molar Ratio of Sodium Fluoride to Phosphorous Pentachloride

Two Hastelloy autoclave (A and B), with non-metallic wet parts for reacting NaF and PCl5 in the molar ratio 1:1.2 were used. To the reactor B was charged high purity sodium fluoride (100 g). Flushed the assembly with nitrogen. Cooled the assembly to 5-10° C. Charged battery grade AHF (800 g) from cylinder in controlled condition. Allow the mixture to stir.

Reactor A was charged PCl5 (594 g). Slowly dosed AHF in lots of 100 to 200 g at 25 to 40° C. (in totality 380 g) in 24 to 30 hrs. timeframe. In between the pressure generated due to formation of PF5 and HCl gas in reactor A was dosed to Reactor B through vent system without any Dip-tube till constant pressure. The PF5 gas reacted with NaF in AHF to give NaPF6 under PF5 gas blanketing. After every 1 hr, the excess pressure due to HCl gas was released to scrubber having basic pH.

After complete consumption of the HF and PCl5 (identified by non-generation of PF5 gas pressure) the reactor was cooled to −15 to −20° C., maintaining the mass for 16 hrs at −15° C. and filtering the solid under pressure. The solid was dried and unloaded. The weight of the isolated sodium hexafluorophosphate is 120 g. The isolated solid was checked for its assay by ion chromatography based on sodium content and found to be 99.85%.

### Example-2: Synthesis of Sodium Hexafluorophosphate Using 1:1.4 Molar Ratio of Sodium Fluoride to Phosphorous Pentachloride

Two Hastelloy autoclave (A and B), with non-metallic wet parts for reacting NaF and PCl5 in the molar ratio 1:1.4 were used. To the reactor B was charged high purity sodium fluoride (100 g). Flush the assembly with nitrogen. Cooled the assembly to 5-10° C. Charged battery grade AHF (400 g) from cylinder in controlled condition. Allow the mixture to stir.

Reactor A was charged PCl5 (694 g). Slowly dosed AHF in lots of 100 to 200 g at 25 to 40° C. (in totality 443 g) in 24 to 30 hrs. timeframe. In between the pressure generated due to formation of PF5 and HCl gas in reactor A was dosed to Reactor B through vent system without any Dip-tube till constant pressure. The PF5 gas reacted with NaF in AHF to give NaPF6 under PF5 gas blanketing. After every 1 hr, the excess pressure due to HCl gas was released to scrubber having basic pH.

After complete consumption of the HF and PCl5 (identified by non-generation of PF5 gas pressure) the reactor was cooled to −15 to −20° C., maintaining the mass for 16 hrs at −15° C. and filtering the solid under pressure. The solid was dried and unloaded. Weight of the isolated sodium hexafluorophosphate is 321 g. The isolated solid was checked for its assay by ion chromatography based on sodium content and found to be 99.8%.

### Example-3: Synthesis of Potassium Hexafluorophosphate Using 1:1.4 Molar Ratio of Potassium Fluoride to Phosphorous Pentachloride

Two Hastelloy autoclaves (A and B), were used for reacting KF and PCl5 in the molar ratio 1:1.4 were used. To the reactor B was charged high purity potassium fluoride (58 g). Flush the assembly with nitrogen. Cooled the assembly to 5-10° C. Charged purified AHF (200 g) from cylinder in controlled condition. Allow the mixture to stir.

Reactor A was charged with PCl5 (312 g) and slowly dosed AHF in lots of 20-50 at 25 to 40° C. (in totality 220 g) in 24 to 30 hrs. timeframe. In between the pressure generated due to formation of PF5 and HCl gas in reactor A was dosed to Reactor B through vent system without any Dip-tube till constant pressure. The PF5 gas reacted with KF in AHF to give KPF6 under PF5 gas blanketing. After every 1 hr, the excess pressure due to HCl gas was released to scrubber having basic pH.

After complete consumption of the HF and PCl5 (identified by non-generation of PF5 gas pressure) the reactor was cooled to −15 to −20° C., maintaining the reaction mass for 16 hrs at −15° C. and filtering the solid under pressure. The solid was dried and unloaded. Weight of the isolated potassium hexafluorophosphate is 158 g.

The foregoing description of the invention has been set merely to illustrate the invention and is not intended to be limiting. Since the modifications of the disclosed embodiments incorporating the spirit and substance of the invention may occur to the person skilled in the art, the invention should be construed to include everything within the scope of the disclosure.

1. A process of preparing an ultra-high purity alkali metal hexafluorophosphate (MPF6), comprising following steps:
a. charging alkali metal fluoride (MF) in a first reactor ‘B’ and flushing nitrogen gas through the same,
b. cooling the first reactor ‘B’ to a predetermined temperature, followed by charging anhydrous hydrogen fluoride (AHF) gas and stirring the mixture comprising alkali metal fluoride (MF) dissolved in AHF in the first reactor ‘B’,
c. cooling the mixture comprising alkali metal fluoride (MF) dissolved in AHF in the first reactor ‘B’ to a predetermined temperature,
d. charging phosphorous pentachloride (PCl5) in a second reactor ‘A’ and adding AHF in multiple lots, to produce high purity phosphorous pentafluoride (PF5) and hydrogen chloride (HCl) gas,
e. reacting alkali metal fluoride (MF) dissolved in AHF in the first reactor ‘B’ with phosphorus pentafluoride (PF5) and hydrogen chloride (HCl) gas mixture obtained in step (d) to obtain alkali metal hexafluorophosphate mother liquor dissolved in AHF under PF5 gas blanketing,
f. cooling the first reactor ‘B’ to a predetermined temperature and maintaining the temperature of alkali metal hexafluorophosphate mother liquor dissolved in AHF for predetermined time, followed by filtration and drying at predetermined temperature to achieve alkali metal hexafluorophosphate (MPF6),
g. obtaining the dried solid MPF6,
wherein alkali metal ‘M’ is selected from Na, K and Cs and alkali metal hexafluorophosphate is selected from NaPF6, KPF6 or CsPF6.

2. The process as claimed in claim 1, wherein the PF5 and HCl gas from the second reactor ‘A’ was dosed to the first reactor ‘B’ through vent system without any dip-tube till constant pressure.

3. The process as claimed in claim 1, wherein the anhydrous hydrogen fluoride (AHF) gas is purified prior to using it in the process; and wherein the alkali metal fluoride used in the process is obtained from alkali metal bicarbonate and hydrogen fluoride.

4. The process as claimed in claim 1, wherein the predetermined temperature in step (b) and (c) is in the range of 5 to 15° C.

5. The process as claimed in claim 1, wherein the adding AHF is performed in multiple lots at temperature ranging between 25 to 40° C.

6. The process as claimed in claim 1, wherein the predetermined temperature and predetermined time for cooling in step (f) is in the range of −10 to −25° C. for 5 to 17 hours.

7. (canceled)

8. The process as claimed in claim 1, wherein the predetermined temperature for drying in step
(f) is in the range of 35 to 50° C.

9. (canceled)

10. An ultra-high purity alkali metal hexafluorophosphate selected from NaPF6, KPF6 and CsPF6 obtained by the process as claimed in claim 1 having purity of at least 99.8% w/w.

11. The ultra-high purity sodium hexafluorophosphate (NaPF6) as claimed in claim 8, comprising metallic impurities as follows:
$$Fe \leq 2 ppm$$
$$Ca \leq 2 ppm$$
$$K \leq 2 ppm$$
$$Na \leq 2 ppm$$
$$Ni \leq 2 ppm$$
$$Pb \leq 2 ppm$$
$$Zn \leq 2 ppm$$
$$Cr \leq 2 ppm$$
$$Cu \leq 2 ppm$$
$$Mg \leq 2 ppm .$$
